(19) United States
(12) Patent Application Publication
(10) Pub. No.: US 2010/0153846 A1
(43) Pub. Date: Jun. 17, 2010

(54) PLAYLIST MANAGEMENT SYSTEM

(75) Inventor: Gilles Roy, Kanata (CA)

Correspondence Address: HARMAN - BRINKS HOFER CHICAGO;Brinks Hofer Gilson & Lione, P.O. Box 10395, Chicago, IL, 60610, US

(73) Assignee: QNX Software Systems GmbH & Co. KG, Karlsbad (DE)

(21) Appl. No.: 12/634,307

(22) Filed: Dec. 9, 2009

Related U.S. Application Data
(60) Provisional application No. 61/138,384, filed on Dec. 17, 2008.

(51) Int. Cl. G06F 3/00

(52) U.S. Cl. 715/716

(57) ABSTRACT

A system is disclosed that includes a media player that plays media files, memory storing a plurality of media files, and a media manager. The media manager generates a new playlist of media files based on one or more characteristics associated with a currently playing media file and provides the new playlist to the media player for playback.

### RELATED APPLICATION

This application claims the benefit of U.S. Provisional Application No. 61/138,384, filed Dec. 17, 2008, the entirety of which is incorporated by reference herewith.

### BACKGROUND OF THE INVENTION

1. Technical Field

The systems and/or methods relate generally to the field of computer resource management, and in particular, to a processing system that manages access to media and/or multimedia content.

2. Related Art

Many computer and electronic devices have interfaces that allow a user to navigate through a collection of available audio, audio/visual and other related media or multimedia selections for playback. These may include, for example: songs, videos and multimedia presentations.

As the size of the collection grows, managing access to the available selections may become difficult. If, for example, the user has access to a significant number of songs, it may be difficult for the user to review a list of available song titles to identify a desired selection for playback. Organizing titles by genre or album may provide an improvement in the user experience. This approach, however, may be difficult to implement as the size of the collection grows.

### SUMMARY

A system and/or method, generally referred to as system, is disclosed that includes a media player that plays media files, memory storing a plurality of media files, and a media manager. The media manager generates a new playlist of media files based on one or more characteristics associated with a currently playing media file and provides the new playlist to the media player for playback.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The system may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a processing system.

FIGS. 2 and 3 are media or multimedia playlists, showing how the user may transition from a currently playing song to a new playlist.

FIG. 4 is a process for transitioning from a current song to a related playlist matching one or more characteristics of the current song.

FIG. 5 is a process for transitioning from a current song to a new playlist.

FIG. 6 is a process for transitioning from a current song to a related existing playlist matching a selected characteristic of the current song.

FIG. 7 is a process for transitioning from a current song to a newly generated playlist based on characteristics of the current song.

FIG. 8 is a process for transitioning from a current song to a folder in a “repeat folder” application.

FIG. 9 is an example of a media or multimedia playlist.

FIG. 10 is an example of a new media or multimedia playlist after transitioning from the playlist of FIG. 9.

FIG. 11 is an operational architecture for the system in FIG. 1.

FIG. 12 is a timing diagram for a transitioning process.

### DETAILED DESCRIPTION OF THE PREFERRED EMBODIMENTS

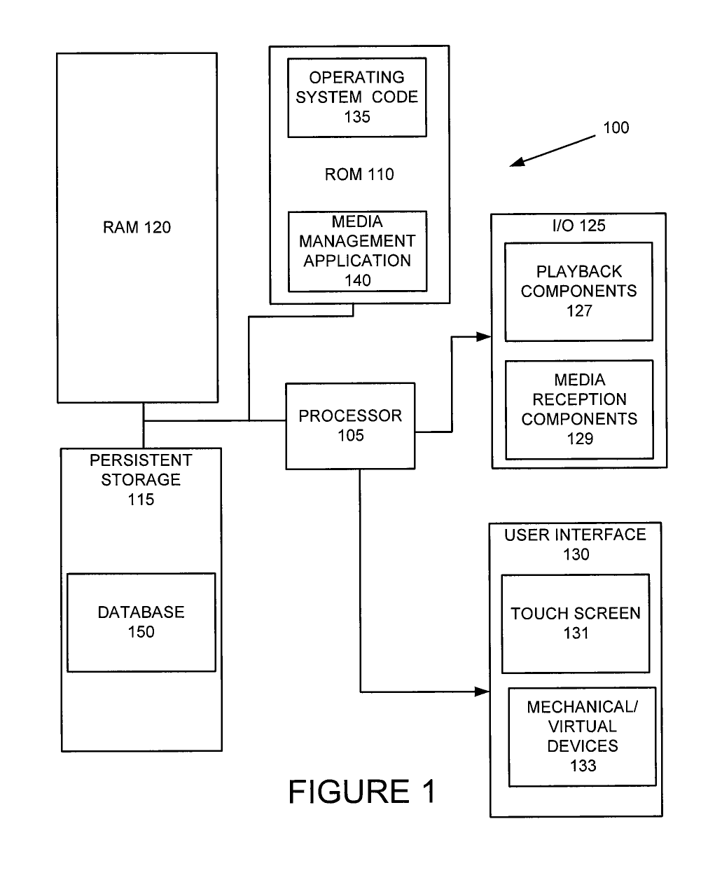

FIG. 1 is a block diagram of a processing system 100. The processing system 100 may include a processor 105, a memory storage unit such as read only memory (ROM) 110, and a persistent storage unit 115. Processing system 100 also may include random access memory (RAM) 120, an I/O (input/output) interface 125, and a user interface 130. The processor 105 may be a single processor, multicore processor, or any arrangement of one or more digital signal processors, microcontrollers or similar devices.

Processing system 100 may support the playing and presentation of media and multimedia content through the user interface 130. To this end, the user interface 130 may include one or more display screens, one or more touch screens (at 131), mechanical and virtual buttons (at 133), and/or other interface components. The I/O interface 125 may include a media playback device, for example a variety of audio playback components 127, such as audio amplifiers and speakers, hard-wired or wireless headsets, earphones, and similar audio and/or visual devices. The I/O interface 125 may also include one or more media reception components 129 that may be used to receive media files and/or multimedia files from external sources such as a wired and/or wireless LAN, a WAN, the Internet, a subscription service, a further processing system, an external storage device, and the like.

Read only memory (ROM) 110 may retain operating system code 135 that controls the interaction between application programs executed by the processor 105, including high-level programs, and hardware components, including memory devices 110 and 120, the persistent storage unit 115, and the interfaces 125 and 130. The operating system code 135 may include a media management application 140 that may include executable media management code for, among other things, organizing and controlling access to the various system components used for media/multimedia operation. Alternatively, the media management application 140 may be stored in a separate medium remote from operating system code 135. In some systems, the media management application 140 may be stored in read only memory 110, persistent storage unit 115, or in some other storage medium. When the processing system 100 is linked with other computers and/or storage devices through I/O interface 125, the media management application 140 may be stored remotely and downloaded to processing system 100 as needed. FIG. 1 illustrates storage of the media management application 140 in read only memory 110.

The persistent storage unit 115 may comprise a hard disc drive, floppy disk drive, optical drive such as a CD (compact disk) player/writer, data or video DVD (digital versatile disk) player/writer, a thumb drive, USB memory stick, memory card or similar device, and any necessary ports and/or connectors. It may be a non-rotating media device, such as non-volatile memory implemented in an integrated circuit format (for example FLASH memory, etc.). The persistent storage unit 115 need not be limited to a single memory structure. Rather, the persistent storage unit 115 may include a number of separate storage devices of the same type (e.g., all FLASH memory) and/or separate storage devices of different types (e.g., one or more FLASH memory units and one or more hard disk drives).

The media management application 140 may be executed by processor 105 to generate a database 150 for storing information relating to image files, audio files, video files and other multimedia content accessible to the processing system 100. In system 100, the media management application 140 generates the database 150 in the persistent storage 115, although other storage locations may be used for the database 150. The database 150 may also identify mediastores that may be part of and/or available to system 100. Such media storage may include data CDs, data DVDs, video DVDs, USB sticks, MP3 players, iPod™ or similar components and, for example, may form at least part of the playback components 127. In the case of an image file, the information stored in database 150 may include a title, textual description, copyright information, camera make and model, date and time, and location. In the case of a song file, the information stored in database 150 may include song name, album name, track number, album cover graphics, lyrics, artist, label, release year and musical genre. In the case of a video file, the information stored in database 150 may include administrative and structural information, including, for example: title, director, producer, digital rights management data, data format, and encoding. The available information for a particular media type may vary in accordance with varying standards in existence at any given time, and the media management application 140 may be executed to obtain the data in accordance with those standards.

The media content associated with the database entries as well as the information relating to the media content may be stored locally in the persistent storage 115. It may also be remote, for example, on a remote system or web server, accessible through the I/O interface 125, on a local area network (LAN), wide area network (WAN), over the Internet or accessible in some other manner.

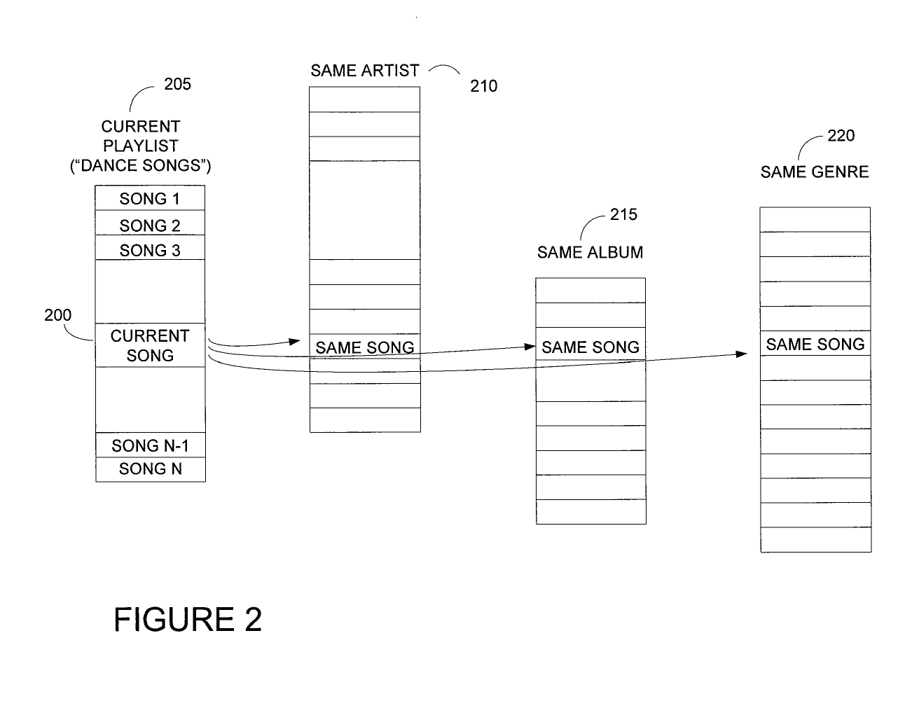

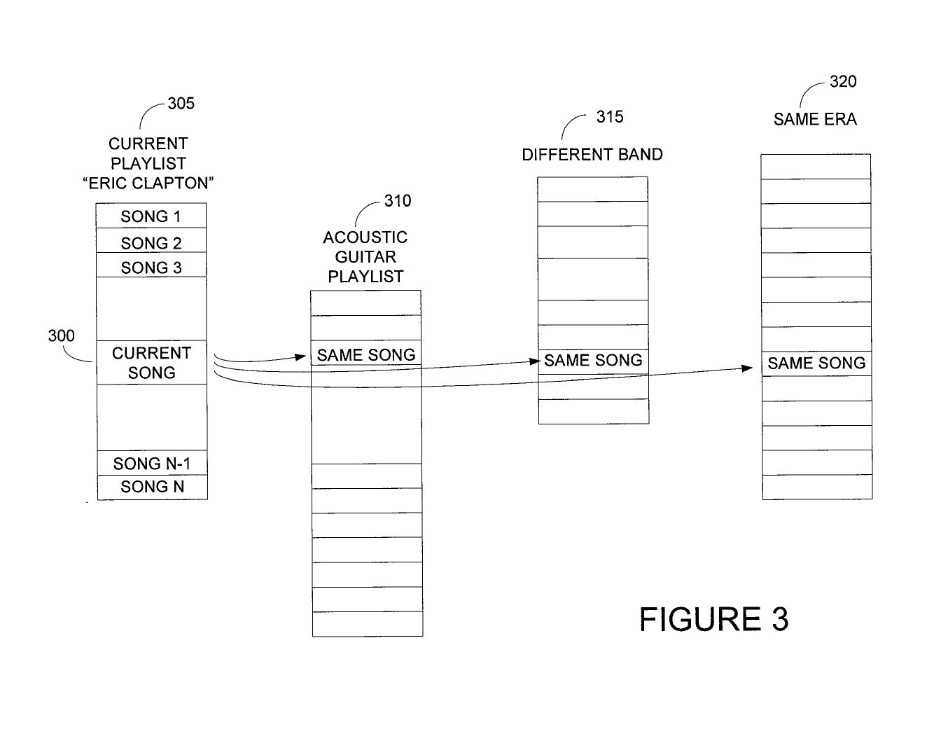

FIGS. 2 and 3 are media or multimedia playlists managed through execution of the media management application 140, showing how a user may transition from a currently playing song to a new playlist. Each playlist may be a list of songs for playback, which may or may not be in a specific order. If no order is specified, the songs of a playlist may be played in the order in which they are stored on the persistent storage unit 115, the order of the tracks on an album, the order in which the songs are listed on the playlist, etc. In FIGS. 2 and 3, the user requests a new song playlist through the user interface 130. In response, the system 100 transitions from a currently playing song, for example, in a playlist of songs, to a new playlist of songs that includes the currently playing song without interrupting the playback of the currently playing song. To this end, the media management application 140 locates the position of the currently playing song in the new playlist, and all counters and offsets may be adjusted with respect to this new position so that commands like “Next” and “Prey” may apply to the new playlist. This transition may be executed automatically by the media management application 140 when generating the new playlist without necessarily needing an API. The currently playing song need not stop playing when the new playlist is used for playback. Audio may be uninterrupted and there may be a smooth transition into the next song that may be played. An event may be emitted that notifies client applications to request the updated track count and position information.

In FIG. 2, the system is playing a song 200 in a “dance songs” playlist 205. The user may enter commands through the user interface 130 that direct the media management application to transition to other playlists that have the same song, such as other playlists by the same artist 210, the same album 215 or the same genre 220. Although only one playlist is shown in each case, there may be several playlists for each option. The playlist options may be presented to the user for selection through the user interface 130. The same song may appear on a studio album, a live album and a “greatest hits” album. Transitioning may be effected by transitioning into the desired playlist at the location of the occurrence of the same song. In a “random” mode, the songs in a given playlist need not be played in any particular order, and the starting location may be inconsequential.

In FIG. 3, the user may be listening to a particular acoustic guitar song 300 in an “Eric Clapton” playlist 305. Through the user interface 130, the user may transition into playlists for “acoustic guitar songs” 310, a playlist which includes a version of the song performed by another band or artist 315, or a playlist for songs of the same era 320.

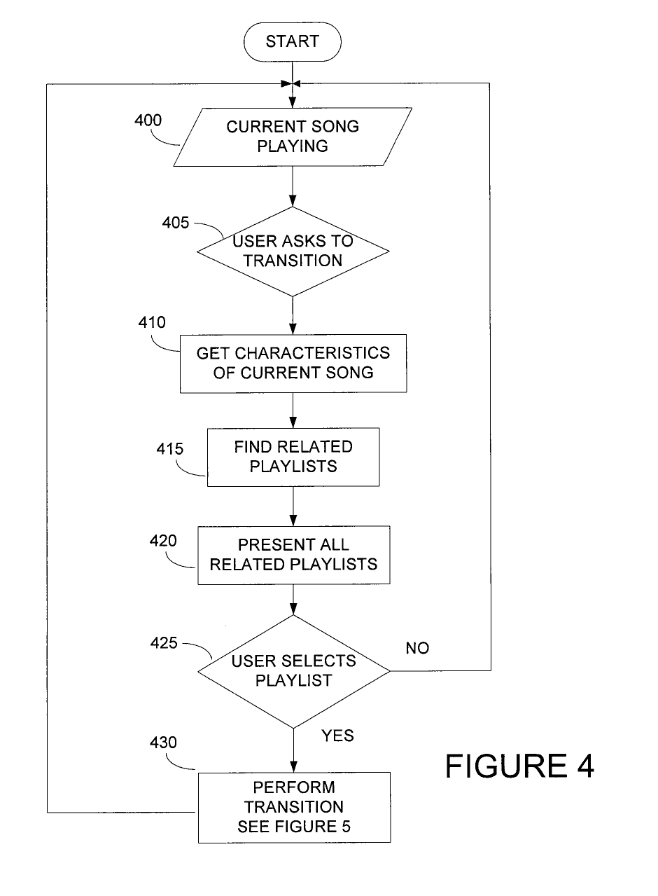

FIG. 4 is a process for transitioning from a current song to a related playlist matching one or more characteristics of the current song. In FIG. 4, when a song is currently playing, the user may enter a command through, for example, user interface 130 to direct the media management software 140 to transition from a currently playing song 400 to a related playlist. The nature of the interface may depend on the device but may include, for example, striking a mechanical hot key, striking a software key on a touch screen, using a mouse to click on a pull down menu selection, clicking on a radio button on a graphic user interface (GUI), or similar command entry. When the user requests a transition at 405, the system may obtain the metadata characteristics of the current song at 410, which may or may not be stored locally. This metadata may include, for example: Artist, Album, Genre, Folder, Composer, Era, Origin of band, number of beats per minute, rhythm and/or similar criteria. This metadata may be used to find related playlists at 415, that is, playlists which have one or more of the same characteristics as the currently playing song. The resulting playlists may be presented to the user at 420. The user selects one of these presented playlists at 425 and the system transitions to the new playlist at 430. If no selection is made at 425, the system can time out and return control to the playing of the current song at 400.

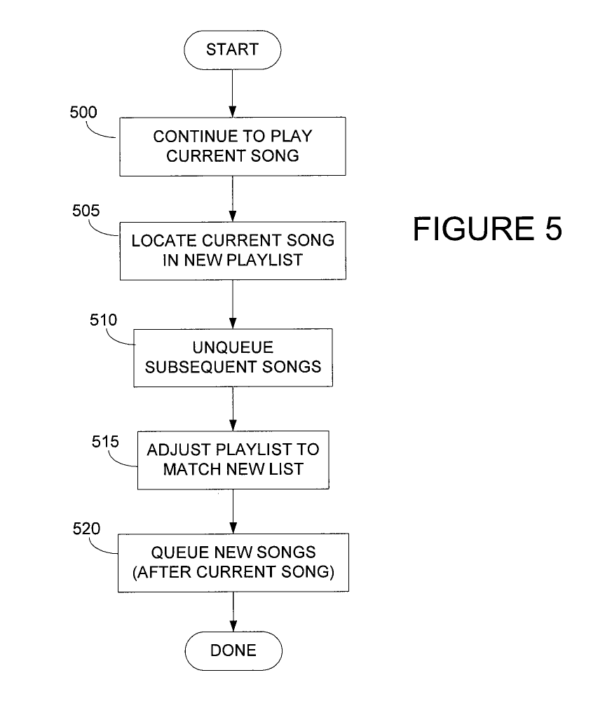

FIG. 5 is a process for transitioning from a current song to a new playlist. While continuing to play the current song at 500, the media management application 140 searches for the currently playing song in the new playlist at 505. Then, without stopping playback of the current song, it un-queues any subsequent songs 510 and adjusts the current playback parameters (such as the current track index, number of tracks, history, etc.) to match those of the current track in the new playlist 515. The media management application 140 may then queue the subsequent tracks of the new playlist for playback 520. This allows for a smooth transition to the new next track without interrupting the playback of the current song. If the user hits the “prey” button immediately after the transition, the media management application 140 may direct the system to play the previous song to the current one in the new playlist.

Transitions may be made in response to selection of various criterion. For example, transitions may be made when the user identifies certain characteristics of the current song. The media management application 140 may use the selected characteristics to find a set of related playlists to choose from. This allows a smooth transition from one group of songs (a list, track session, playlist, etc.) to a new group/list of songs. In each instance, however, the media management application 140 may limit selection of a new playlist meeting the selected characteristic to a playlist that contains the currently playing song. As such, the currently playing song is located somewhere in both lists. The position of the currently playing song in both lists may be different, but the audio is not interrupted when transitioning from one list to the next.

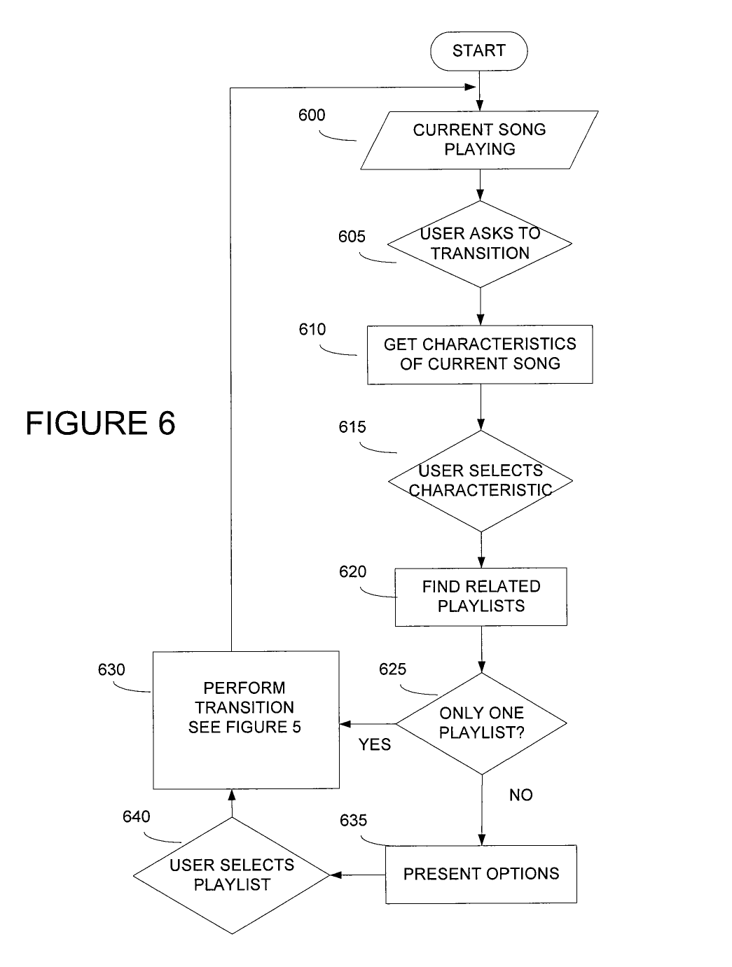

In FIG. 4, a user may transition from a currently playing song of a playlist to a different playlist by identifying particular characteristics of the current song. Transitioning may occur to a related playlist using selected characteristics. Referring to FIG. 6, while a song is currently playing at 600, the user may indicate an interest in transitioning at 605 through, for example, user interface 130. When the user requests a transition, the system may obtain the metadata characteristics of the current song 610, and allow the user to select one or more of the characteristics found in the metadata that are to be used by the media management application 140 as a basis for the transition at 615 to another playlist. This may be done in a number of ways, such as:

1. Presenting a listing of all characteristics (Artist, Album, Genre, Folder, Composer, Era, Origin of band, Other bands with the same artist, beats per minute, rhythm, etc.);
2. Presenting only those characteristics that have been stored for that song, either not displaying the missing characteristics in the menu, or graying them out; or
3. Integrating steps 605 and 615 together into a single step where the user is presented with buttons such as “transition to artist”, “transition to album”, “transition to genre”, etc. These options could similarly be grayed out or omitted from the menu where they are not available or are not applicable.

If the system recognizes that there is only one such playlist available at 625, the transition is made at 630 (either with or without a user confirmation). Otherwise existing playlists matching the selection criteria may be located and presented to the user at 635. The user may select an existing playlist at 640 as a new playlist, and the system executes a transition to the new playlist at 630.

The media management application 140 may include “play similar music” functionality. While playing a song, one or more new playlists of similar songs may be generated, allowing the user to choose one and transition to it. One could instantly start playing a new song on a new list (interrupting the currently playing song), but using the transitioning playlist system, one could continue playing the current song while transitioning. That is, the current song continues to play but the songs around it (the previous ones and the next ones) would change, assuming that the currently playing song is included somewhere in the new playlist.

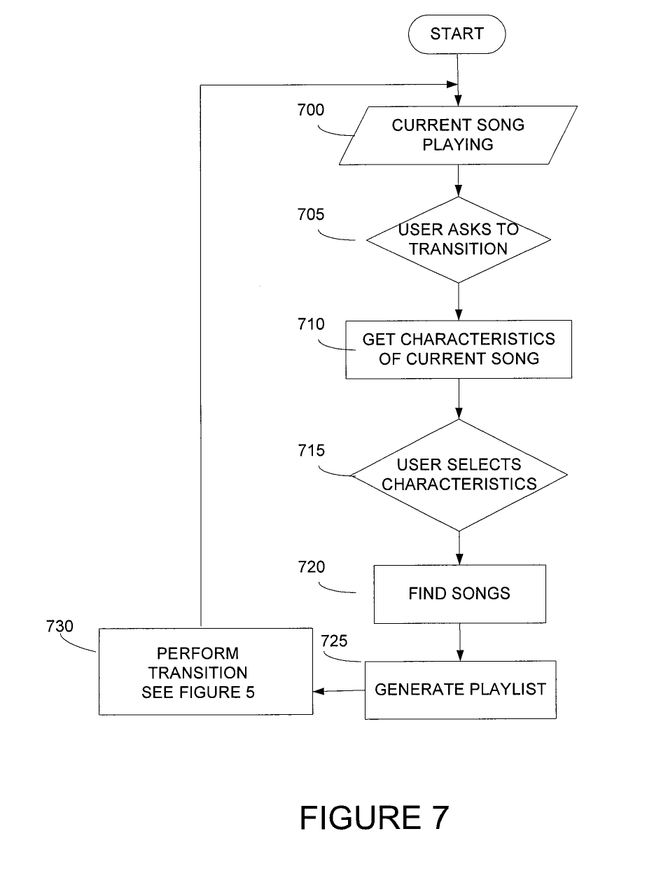

FIG. 7 is a process for transitioning from a current song to a newly generated playlist based on characteristics of the current song. Referring to FIG. 7, while a song is currently playing at 700, the user may indicate an interest in transitioning at 705 through, for example, user interface 130. When the user requests a transition, the system may obtain the metadata characteristics of the current song at 710, and allow the user to select the characteristics upon which the transition is to be based at 715. An HMI (human-machine interface, such as a GUI or graphic user interface) with an informative screen could be used to do this. When the user opens this screen, the user may be presented with all of the current song characteristics that may be used to generate the new playlist. The user may select one or more of the characteristics, for example, by checking options off on a list presented on the interface. Songs corresponding to the selected characteristics are located by the media management application at 720 and a new playlist is generated at 725. The system then transitions into this new playlist at 730.

Alternatively, or in addition based on user preferences, the collecting of characteristics of the current song at 710, locating similar songs at 720, and generating one or more new playlists at 725 may be performed automatically, with the results presented to the user. In such an implementation, the user's request to transition at 705 and selecting of characteristics at 715 are merged together, the selection of one of the automatically generated playlists performing both tasks. The song metadata presented to the user may include, for example: Artist, Album, Genre, Folder, Composer, Era, Origin of band, beats per minute, rhythm and similar criteria. When coupled with an embedded or online database (commercial and/or non-commercial), sophisticated processing playlist generation based on what instruments are being used by the Artist (for example play more Eric Clapton where he is playing an acoustic guitar).

The media management application 140 may include “repeat folder” functionality. When the user selects or turns this mode on, the system may create a new playlist of all the files in the current folder (for example, the folder in which the currently playing song resides, which may be, for example, a USB stick or a data CD) and then transitions into this new playlist for playback. The media management application 140 may also execute a wraparound playback feature so that playback of songs may continue from a beginning of a playlist when play hits an end of the playlist. A position of a song in the playlist may not matter since all of the songs in the playlist may eventually be played by way of the wraparound playback.

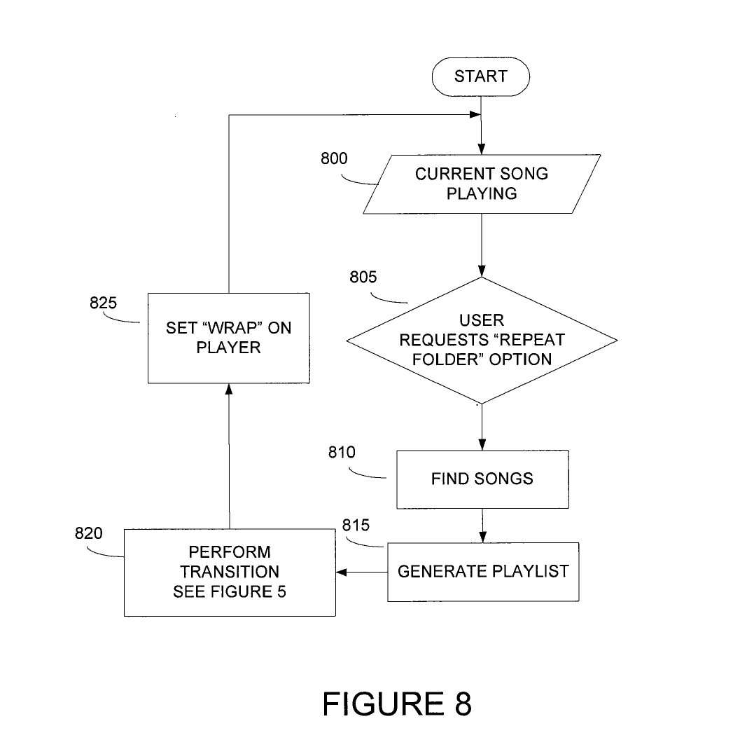

The associated set of characteristics may include a location of files in a disk hierarchy, such as media files that are located in a same folder as the folder of the currently playing media file. FIG. 8 is a process for transitioning from one media file to another media file, such as transitioning from a current song to other songs in a folder for a “repeat folder” application. In FIG. 8, while a song is currently playing at 800, the user may indicate his interest in selecting the “repeat folder” mode through, for example, user interface 130 at 805. The system may then identify all of the songs in the current folder at 810 and generate a new playlist 815. The system then transitions into this new playlist at 820 and sets the “repeat” or “wrap” option at 825.

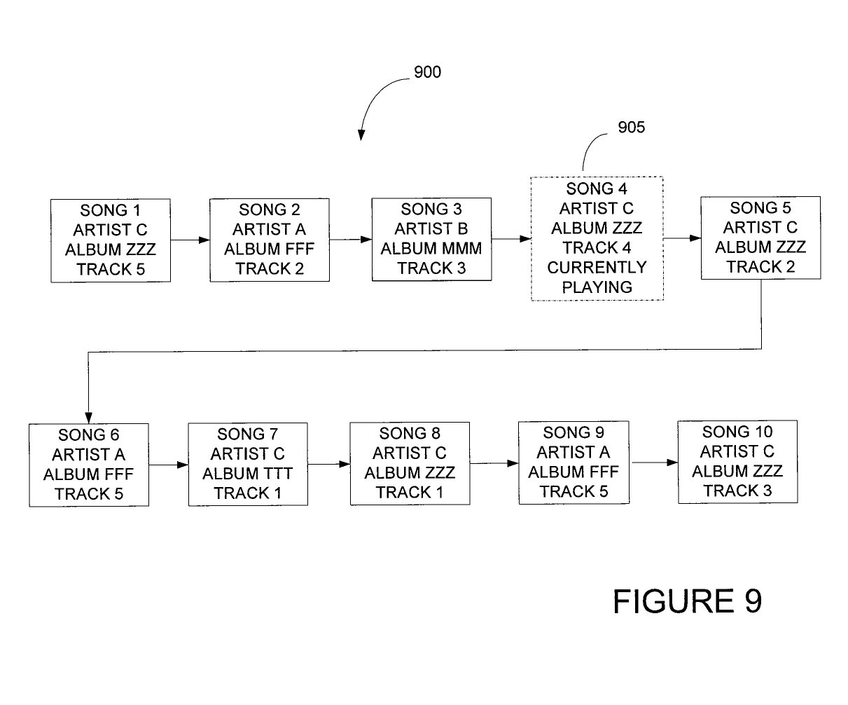

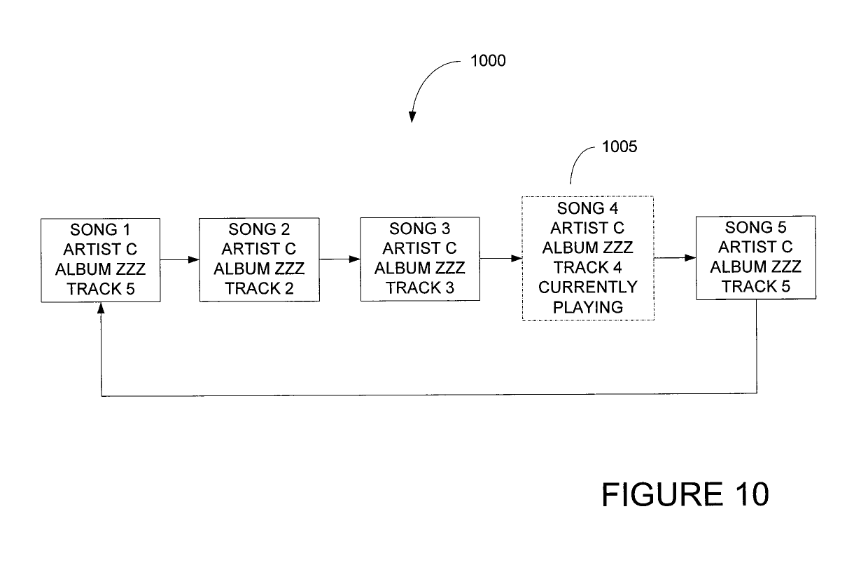

In a play the album function of the media management application 140, the media management application 140 may create a new playlist from all songs in the album corresponding to the currently playing song and then transitions into the new playlist. In FIGS. 9 and 10, even if the system enters the new playlist near the end of the new playlist, it is possible to use the wrap/repeat mode so that the media management application 140 restarts the playlist from the beginning. All of the songs in the playlist may be eventually played.

In FIG. 9, Song 4 is playing at 905 as part of the playlist 900 of ten songs. The current playlist includes a list of all songs found, for example, on a USB memory stick. There may be more songs than the ten in FIG. 9, possibly several hundred. If the user does not take any action, the system continues to step incrementally through the ten songs in FIG. 9.

If the user enjoys the currently playing Song 4 by Artist C 905, the user may decide to hear more songs from the same album (ZZZ). The user may enter a corresponding command through, for example, user interface 130, to direct the system to generate a new playlist 1000 of all songs from Album ZZZ, in FIG. 10. The system may also perform a smooth transition to this new playlist by transitioning to Song 4 in the new playlist 1005.

The old position might have been index 56 out of 305 (that is, song number 56 in a playlist of 305 songs), but there are only 5 tracks in the new playlist. Since the system was playing track 4 of the album, it may now be in position 4 out of 5, assuming that random/mix mode is off; if random was on, the system may be in a random position in the new playlist. Also, since the system is at position 4/5, the user has already missed songs 1 through 3, but by turning on wrap/repeat all mode, playback of the songs of the playlist are repeated. Consequently, the user may hear the remainder of song 4, followed by track 5, track 1, track 2, track 3, track 4, etc. of FIG. 10, until deciding to play something else.

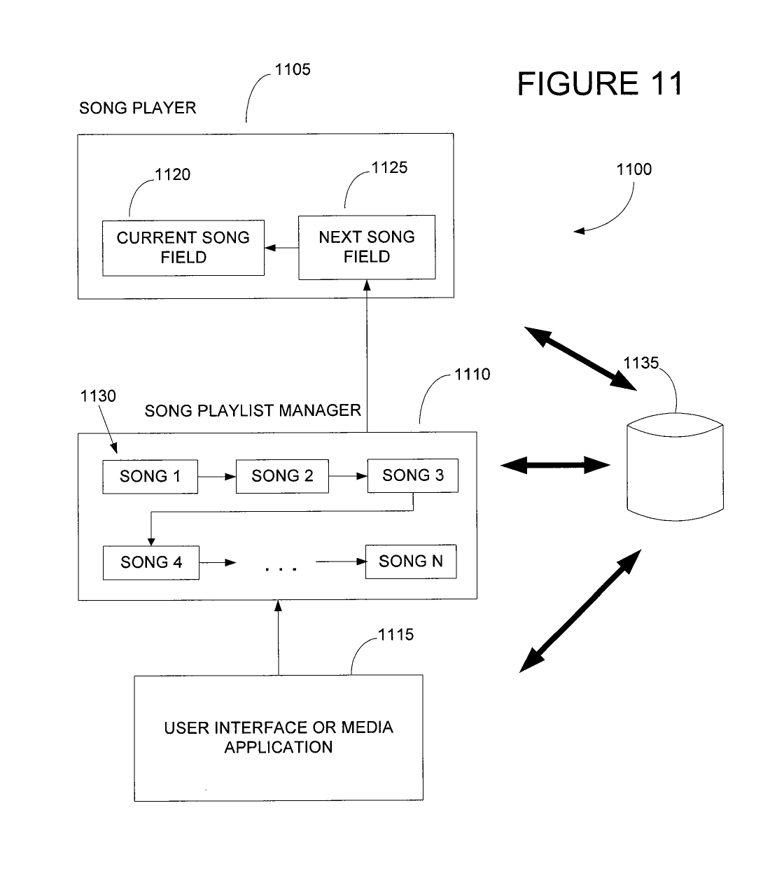

FIG. 11 includes an operational architecture for the system in FIG. 1. The architecture 1100 may include one or more of the following modules: a media player, for example song player 1105, a media manager, for example song playlist manager 1110, and a user interface, for example under interface or media application 1115. Alternatively or in addition, other modules may be included. The song player 1105 may be responsible for decoding and playback of songs. It may be directed to play a specific song and which song to play next. These selections may be stored in the “current song” 1120 and “next song” 1125 fields. The higher level song playlist manager 1110 may be responsible for the overall playlist 1130 and the order in which songs are played. The user may interact with the system through the user interface or media application 1115, making selections with regard to playlists and song characteristics. One or more of these modules may access various portions of the media content and information in a database 1135.

The operational architecture 1100 of the system 100 may be implemented in many ways. In one example, the song playlist manager 1110 or other media manager may include media management code executable by a processor, for example processor 105 in FIG. 1, to organize and generate media file playlists for playback on the song player 1105 or other media playback device. The media file playlists may include at least one playlist having a currently playing media file, for example stored in the “current song” field 1120, and at least one alternative playlist having a next media file, for example stored in the “next song” field 1125. The next media file and the currently playing media file may share an associated characteristic, for example a same artist, album or genre. The media management code may be responsive to a playlist transition command of the user interface or media application 1115 to direct the song player 1105 to play the next media file of the at least one alternative playlist.

When a transition to a new playlist occurs, the song player 1105 may be directed to play a different song as the next song 1125. Thus, it continues playing the current song 1120 until it is finished. The system makes sure that the current song 1120 is in the new playlist. Just before doing this, the song player 1105 may be instructed to discontinue playback of any new song 1125 once the current song 1120 ends. Otherwise a race condition may result. Even if the current song 1120 ends, the new next song 1125 may start very quickly, so the interruption should not be audibly noticeable. If the currently playing song 1120 is not in the new playlist, an error may be returned to the user through the user interface. This error may indicate that the playlist specified was invalid for the requested transition.

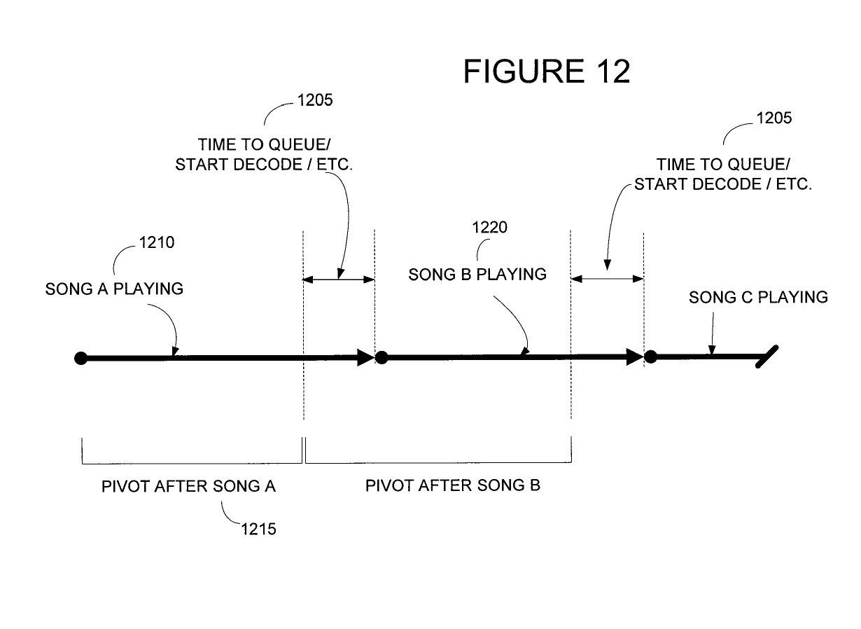

FIG. 12 is a timing diagram for a transitioning process. If the user requests a track transition towards the end of a song, the system may not be able to process the request in time to result in a smooth transition from the current song to the new one. In FIG. 12, some systems may have a latency at 1205 as the system locates and begins downloading of a new song from a storage device of some kind, queues the song, and possibly begins decoding of the content. For example, a compact disk (CD) player in an automobile may have an access time as much as a half a second. Alternatively, the song player 1105 may have begun processing a new song even though it is still playing the current song 1120. In such a case, it may be desirable to continue with the playback of the new song 1125 that the system has already begun processing, assuming there may not be enough time for a smooth transition to the new playlist that the user has requested.

Although a song such as Song A may still be playing at 1210, the system may restrict response to a request for a transition to a shorter period of time 1215 in order to smoothly effect the transition. If that window is missed, transitioning may be performed after song B has been played 1220.

If a request for a new playlist is received during latency 1205, there are a number of possible strategies for proceeding. If the next song in the queue to be played is also part of the new playlist, the playback may continue from the next song. To the user the transition to the next song may be perceived as being generally inconsequential since it was part of the new playlist.

If the request is not received in time to make a smooth transition, it is more likely that the next song played is not on the new playlist. This may be considered a missed transition. The intention of the user was to transition on the previous song to a song on the new playlist, but that can no longer be done without interrupting playback (because now a new, unwanted song is playing). The system can either start the playback from the beginning of the new playlist or fail the request. There are several ways in which a missed transition may be detected, including the following:

1. The song player 1105 may send an event to the song playlist manager 1110 each time it changes tracks. If such an event is received by the song playlist manager 1110 while it is processing a transition, then the song playlist manager 1110 may respond to the event in a manner indicating that the song player 1105 has already moved on to another song that may or may not be on the new list; or
2. The song playlist manager 1110 may check to see what the current song is on the song player 1105 before effecting a transition. If the song playlist manager 1110 detects that the currently playing song is not in the new playlist, then it may determine that the transition was missed.

If a transition is missed, a specific error code may be issued. If the system detects an error code indicating that a transition was missed, it may have several options for responding, including for example:

1. Creating a new playlist on the current song and making a smooth transition to that playlist. The user may therefore know they pressed the button too late and missed the song they were actually targeting;
2. Stopping the small portion of the new song that has started playing, setting the new playlist and playing the wanted song from where it would have started had the initial request to set the new playlist been received sooner;
3. Failing the user request and continuing playback of the current playlist; and/or
4. Reporting an error to the user.

Assuming that the currently playing song is still playing and is also in the new playlist, the system may set the new song that should be played next (next new song). If the song player 1105 finished playing the currently playing song during the transition, the system may request that play resume on the next new song. In this manner, the user perceives that the system worked correctly, because the user launched the new playlist substantially at the end of song playback. Then the system may update the offsets (position into the playlist) and provide the new state to the controlling HMI. This may complete the transition to the new playlist.

Further alternative/supplemental implementations of the system may also be provided. For example:

1. The system described is independent of how the media selections themselves are identified or managed. Each media selection, however, may have a unique identifier, or a filesystem name. Instructions and requests may be communicated using SQL or in some proprietary manner;
2. The order in which songs are collected may be specified by the user, be determined by default settings, or be determined by the architecture of the underlying system. For example, songs may be sorted by the order in which they appear in the filesystem, by their physical location on a hard drive, or by track number on an album;
3. A transitioning system, for example of the song playlist manager 1110, may be offered as an option to the user, so that different transitions may be performed depending on the user's preferences. The user may select their preferences via the user interface or media application 1115. Such preferences may include:
a. transition after finishing current song;
b. transition after finishing current song, if it appears on the new playlist;
c. transition immediately, if the current song does not appear on the new playlist; and/or
d. transition immediately, in all cases;
4. A playlist may be displayed to the user before transitioning into it. However, if the user waits too long, the list could become stale. For example, if the user is playing song 34 and pulls up a list of similar songs, but does nothing when the list is presented and song 35 starts playing, then the list is not valid, because song 35 is no longer related to it.

The methods and descriptions of FIGS. 1 and 2 may be encoded in a signal bearing medium, a computer readable medium such as a memory that may comprise unitary or separate logic, programmed within a device such as one or more integrated circuits, or processed by a controller or a computer. If the methods are performed by software, the software or logic may reside in a memory resident to or interfaced to one or more processors or controllers, a wireless communication interface, a wireless system, an entertainment and/or comfort controller of a vehicle or types of non-volatile or volatile memory remote from or resident to a detector. The memory may retain an ordered listing of executable instructions for implementing logical functions. A logical function may be implemented through digital circuitry, through source code, for example media management code, through analog circuitry, or through an analog source such as through an analog electrical, or audio signals. The software may be embodied in any computer-readable medium or signal-bearing medium, for use by, or in connection with an instruction executable system, apparatus, device, resident to a vehicle or a hands-free system communication system or audio system. Alternatively, the software may be embodied in media players (including portable media players) and/or recorders, audio visual or public address systems, desktop computing systems, etc. Such a system may include a computer-based system, a processor-containing system that includes an input and output interface that may communicate with an automotive or wireless communication bus through any hardwired or wireless automotive communication protocol or other hardwired or wireless communication protocols to a local or remote destination or server.

A computer-readable medium, machine-readable medium, propagated-signal medium, and/or signal-bearing medium may comprise any medium that contains, stores, communicates, propagates, or transports software for use by or in connection with an instruction executable system, apparatus, or device. The machine-readable medium may selectively be, but not limited to, an electronic, magnetic, optical, electromagnetic, infrared, or semiconductor system, apparatus, device, or propagation medium. A non-exhaustive list of examples of a machine-readable medium would include: an electrical or tangible connection having one or more wires, a portable magnetic or optical disk, a volatile memory such as a Random Access Memory “RAM” (electronic), a Read-Only Memory “ROM,” an Erasable Programmable Read-Only Memory (EPROM or Flash memory), or an optical fiber. A machine-readable medium may also include a tangible medium upon which software is printed, as the software may be electronically stored as an image or in another format (e.g., through an optical scan), then compiled by a controller, and/or interpreted or otherwise processed. The processed medium may then be stored in a local or remote computer and/or machine memory.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A system comprising:
a media player operable to play media files;
memory storing a plurality of media files, each of the media files having an associated set of characteristics; and
a media manager operable to generate a new playlist of media files based on a selected one of the associated set of characteristics of a currently playing media file and to provide the new playlist to the media player for playback.

2. The system of claim 1, where the media manager further directs the media player to finish playing the currently playing media file before playing a media file of the new playlist.

3. The system of claim 1, where the associated set of characteristics includes a same artist, album or genre of the currently playing media file.

4. The system of claim 1, where the associated set of characteristics includes media files located in a same folder as the currently playing media file.

5. The system of claim 1, where the associated set of characteristics includes an acoustic version of the currently playing media file, a performance of the currently playing media file by a different group, or a same era of the currently playing media file.

6. The system of claim 1, where the media manager further directs the media player to transition immediately from the currently playing media file when the currently playing media file does not appear on the new playlist.

7. The system of claim 1, further comprising a user interface to display the new playlist before transitioning from the currently playing media file.

8. A system comprising:
a memory, the memory to store a plurality of media files;
a user interface operable to receive one or more playback commands including a playlist transition command;
a media playback device responsive to the playback commands received through the user interface; and
media management code executable by the processor to organize and generate media file playlists from the plurality of media files for playback on the media playback device, where the media file playlists include at least one playlist having a currently playing media file and at least one alternative playlist having a next media file, where the currently playing media file and the next media file share an associated characteristic, where the media management code is responsive to the playlist transition command to direct the media playback device to play the next media file of the at least one alternative playlist.

9. The system of claim 8, where the media management code directs the media playback device to finish playing the currently playing media file before transitioning to playback of media files of the at least one alternative playlist.

10. The system of claim 8, where the associated characteristic includes a same artist, album or genre as the currently playing media file.

11. The system of claim 8, where the associated characteristic includes media files located in a same folder as the currently playing media file.

12. The system of claim 8, where the associated characteristic includes an acoustic version of the currently playing media file, a performance of the currently playing media file by a different group, or a same era of the currently playing media file.

13. The system of claim 8, where the media management code further directs the media playback device to transition immediately from the currently playing media file when the currently playing media file does not appear on the at least one alternative playlist.

14. The system of claim 8, where the user interface displays the at least one alternative playlist before transitioning from the currently playing media file.

15. A method for generating media file playlists, comprising:
storing a plurality of media files with a memory storage unit, at least one of the media files having an associated set of characteristics with a currently playing media file;
receiving with a user interface one or more playback commands including a playlist transition command; and
generating, with a processor, media file playlists for playback on a media playback device responsive to the playback commands received through the user interface and based on the associated set of characteristics.

16. The method of claim 15, where the associated set of characteristics includes a same artist, album or genre of the currently playing media file.

17. The method of claim 15, where the associated set of characteristics includes media files located in a same folder as the currently playing media file.

18. The method of claim 15, where the associated set of characteristics includes an acoustic version of the currently playing media file, a performance of the currently playing media file by a different group, or a same era of the currently playing media file.

19. The method of claim 15, where the media file playlists include at least one playlist having a currently playing media file and at least one alternative playlist also having the currently playing media file.

20. The method of claim 19, where the processor is responsive to the playlist transition command to direct the media playback device to play the at least one alternative playlist.

21. The method of claim 19, further comprising transitioning immediately from the currently playing media file when the currently playing media file does not appear on the at least one alternative playlist.

22. The method of claim 19, further comprising displaying the at least one alternative playlist before transitioning from the currently playing media file.
